(19) United States
(12) Patent Application Publication
(10) Pub. No.: US 2016/0323900 A1
(43) Pub. Date: Nov. 3, 2016

(54) METHOD FOR ASSOCIATING TERMINALS WITH CELLS IN A HETEROGENEOUS NETWORK

(71) Applicant: Commissariat a L'Energie Atomique et aux Energies Alternatives, Paris (FR)

(72) Inventors: Antonio DE DOMENICO, Grenoble (FR); Dimitri KTENAS, Voreppe (FR); Valentin SAVIN, Grenoble (FR)

(73) Assignee: Commissariat a L'Energie Atomique et aux Energies Alternatives, Paris (FR)

(21) Appl. No.: 15/138,622

(22) Filed: Apr. 26, 2016

(30) Foreign Application Priority Data
Apr. 28, 2015 (FR) 15 53823

(51) Int. Cl. H04W 72/08; H04W 16/32; H04L 5/00; H04J 11/00; H04W 72/04; H04B 17/318; H04W 24/02

(52) U.S. Cl. CPC H04W 72/085; H04B 17/318; H04W 16/32; H04W 24/02; H04J 11/00; H04W 72/0413; H04L 5/0062

(57) ABSTRACT

A method associates terminals with cells in a network including at least one macro-cell and a plurality of small cells. According to this association method, each terminal performs, for each possible association, a power measurement on the radio link and deduces a quality indicator of that link therefrom. The subset of associations is next selected making it possible to respect the usage constraints of the different users. For each possible association of this subset, a metric characteristic of the overall capacity of the network is computed and an optimal association is determined maximizing this metric.

### TECHNICAL FIELD

The present invention generally relates to the field of cellular telecommunications, and more particularly for heterogeneous networks such as networks of the LTE (Long Term Evolution) or LTE-A (Long Term Evolution Advanced) type.

### BACKGROUND OF THE INVENTION

Traditional cellular telecommunications networks (3G) must deal with increasingly harsh constraints in terms of quality of service (QoS) due to new uses and user needs. To face these constraints, it has been proposed to use heterogeneous networks including several superimposed layers of cells. Traditionally, a heterogeneous network comprises a first layer made up of macro-cells and a second layer made up of substantially smaller cells, called small cells, deployed in an ad hoc manner within the macro-cells. The term “small cells” will be used generically hereinafter. In particular, this term must be understood as covering the notions of picocells and femtocells also present in the literature.

A description of heterogeneous networks can be found in the article by S. Parkvall et al. titled “Heterogeneous network deployment in LTE”, Ericsson Review, vol. 2011.

Relative to traditional cellular networks, heterogeneous networks pose delicate problems, however, regarding load distribution as well as interference between macro-cells and small cells. A description of this issue can be found in the article by R. Madan et al. titled “Cell association and interference coordination in heterogeneous LTE-A” published in IEEE Journal on Selected Areas in Communications, Vol. 28, No. 9, December 2010, pp. 1479-1489.

One of the main difficulties indeed lies in making an association between the terminals or UE (User Equipment) of the different users and the base stations. In other words, for a given terminal, a determination should be made as to what the base station is, i.e., whether it is that of the macro-cells or one of the small cells, with which it will establish the radio link.

The association mechanisms currently proposed for heterogeneous networks are based exclusively on the quality of the radio links between terminals and base stations.

More specifically in an LTE network, each terminal measures the power of the cell specific reference signals (CSRS) emitted by the base station and takes the average of the power of the CSRSs over the different subcarriers (or resource elements, according to the LTE terminology) that carry them. The power thus measured, called Reference Signal Received Power (RSRP), is used by the terminal to compare the quality of the radio links with the different base stations, in particular when the latter is in the standby state.

When a terminal is in communication with the base station, the latter can determine the Received Signal Strength Indicator (RSSI). The RSSI indicator represents the total power of the signal received by the terminal, i.e., the power of the transmitted signal plus noise and interference. The terminal deduces the Reference Signal Received Quality (RSRQ) indicator therefrom, defined as the ratio RSRP/RSSI between the power of the reference signals and the received signal strength indicator. When the terminal is in communication, the RSRQ quality indicator provides information on the quality of the radio link with the base station.

Depending on the standby or communication state of the terminal, it is possible to associate it with a base station from values of RSRP or RSRQ, or even for both values at the same time. The base station with which it is associated can either be that serving the macro-cell, or one of those serving the small cells.

In practice, a heterogeneous network is characterized by a major imbalance between the power emitted by the station serving the macro-cell and the powers emitted by the base stations serving the small cells. This imbalance results in a large proportion of terminals associated with the macro-cell (i.e., with the base station serving the macro-cell) rather than a small cell (i.e., the base station serving a small cell).

This imbalance, and consequently this preferred association with the macro-cell, leads to a reduction in the overall capacity of the network, an increase in the level of interference perceived on the uplinks and a decrease in the lifetime of the batteries of the mobile terminals. Indeed, the latter must emit at a stronger power so as on the one hand to connect with a base station serving a macro-cell that is generally further away than the base stations serving the small cells, and on the other hand, to combat the interference on the uplinks.

In order to offset the load imbalance between macro-cell and small cells, a corrective mechanism has been proposed reflected in an expansion of the coverage of the small cells. More precisely, when the terminal receives a signal from a base station serving a small cell, it corrects the power received from the latter by adding a predetermined positive bias thereto (for example, +3 dB or +6 dB). Thus, in the aforementioned association method, based on the values RSRP and/or RSRQ, the association with a small cell is artificially favored. A description of the aforementioned corrective mechanism can be found in the article by I. Güvenç titled “Capacity and fairness analysis of heterogeneous networks with range expansion and interference coordination” published in IEEE Comm. Letters, Vol. 15, No. 10, October 2011, pp. 1084-1087.

FIG. 1 diagrammatically shows the expansion mechanism for a small cell in a heterogeneous network.

Reference 110 shows a macro-cell served by a base station 115, reference 120 shows a small cell before its expansion, and reference 121 shows that same small cell when after [sic] a positive bias has been added to the received power of the base station 125 serving the small cell. Thus, the user 132 who was located outside the small cell before its expansion is served by the base station 125 after its expansion.

Although this mechanism indeed makes it possible to transfer part of the load from the macro-cell to the small cells, it nevertheless has negative effects on the performance of the network. Indeed, a terminal on the border of a small cell, such as the terminal of the user 132, may suffer from a low signal-to-noise ratio on its downlink due to the interference caused by the macro-cell and, if applicable, the adjacent macro-cells. Furthermore, a significant bias (leading to excessive expansion) may lead to an overload of certain small cells. It is then necessary to use a dynamic adaptation of the bias, which makes the association method particularly complex.

Most of the association mechanisms between terminals and cells in a heterogeneous network seek to optimize only the overall capacity of the network without taking the needs of different users into account. As a result, a user only needing a low quality of service may be allocated a very high-quality link, while an adjacent user needing a very good quality of service will obtain a lower quality link.

The aim of the present invention is therefore to propose an association method between terminals and cells in a heterogeneous network that is not affected by the above limitations, and in particular that makes it possible to take the needs of different users into account.

### BRIEF DESCRIPTION OF THE INVENTION

The present invention is defined by a method for associating terminals with cells in a heterogeneous telecommunications network comprising at least one macro-cell and a plurality of cells, called small cells, with a substantially smaller size than said macro-cell and that are deployed within the latter, the macro-cell and said small cells being served by a plurality of base stations, each terminal being able to establish a radio link with a base station using a frequency resource, according to which:

each terminal performs a power measurement on the frequency resource so as to obtain, for each possible association associating that terminal with a base station, a quality index of a radio link between the terminal and that base station;

among the set (Γ) of possible associations between terminals and base stations, a subset (Γ_{L}) of associations is selected satisfying at least one constraint (L) relative to the use of said terminals, the selection being done from quality indices of the radio links;

for each possible association of said subset, a metric characteristic of the overall capacity of the radio links between terminals and base stations associated using this possible association is computed and an optimal association (S*) is determined maximizing this metric;

radio links are established between the terminals and the base stations associated using the optimal association (S*) thus determined.

According to a first alternative, a setpoint power being assigned to each terminal, the constraint relative to the use of the terminals is the maximum percentage of the terminals able to emit with powers higher than their respective setpoint powers.

According to a second alternative, a setpoint throughput being assigned to each terminal, the constraint relative to the use of the terminals is a maximum percentage of terminals able to receive data throughputs lower than their respective setpoint throughputs.

According to a third alternative, a quality of service (QoS) level being required by each terminal, the constraint relative to the use of the terminals is a maximum percentage of terminals able to have quality of service levels lower than the quality of service levels that they respectively required.

The metric of the radio links between the terminals UEⱼ, j=1, . . . , J and base stations BSᵢ, i=1, . . . , N can be defined by

$${\sum }_{( {UE}_{j} , {BS}_{i} = S ( {UE}_{j} )} {C}_{ij}$$

where Cᵢⱼ is the capacity of the channels between the base station BSᵢ and the terminal UEⱼ, and S is one possible association of said subset.

Alternatively, the metric of the radio link between the terminals UEⱼ, j=1, . . . , J and the base stations BSᵢ, i=1, . . . , N can be defined by

$${\sum }_{( {UE}_{j} , {BS}_{i} - S ( {UE}_{j} )} log {C}_{ij}$$

where Cᵢⱼ is the capacity of the channel between the base station BSᵢ and the terminal UEⱼ, and S is one possible association of said subset.

A heterogeneous telecommunications network can be an LTE or LTE-A network. In this case, the capacity of the channel Cᵢⱼ can be computed from the measurement RSRPᵢⱼ obtained as the average power of the signals CSRSᵢ, specific to the cell served by the base station BSᵢ, on the resource element of that base station.

The association method can be executed with a predetermined period, or automatically each time a terminal requests to connect to the network, or automatically upon each handover procedure of the terminal, or even upon request by a terminal when its battery level is below a predetermined threshold level.

Said association method can be executed in a distributed manner within the different base stations, or in a centralized manner by a controller situated in the base station of the macro-cell.

The maximization of the metric on the subset of associations respecting said usage constraint can in particular be obtained using the Lagrange multipliers method.

### BRIEF DESCRIPTION OF THE DRAWINGS

Other features and advantages of the invention will appear upon reading one preferred embodiment of the invention in reference to the attached figures, in which:

FIG. 1 diagrammatically shows the expansion mechanism for a small cell in a heterogeneous network of the state of the art;

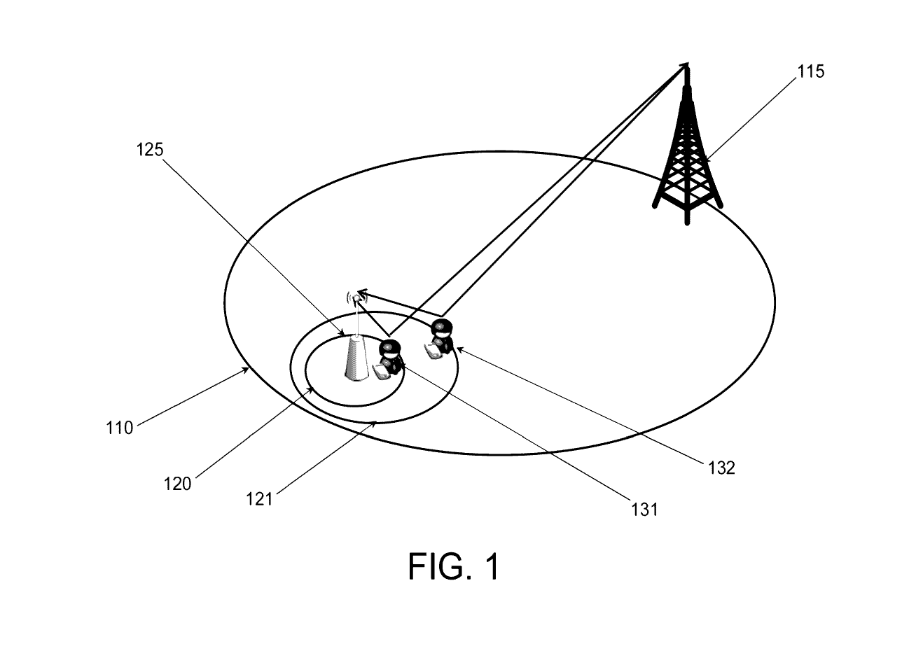

FIG. 2 diagrammatically shows a flowchart of the method for associating terminals with cells according to one embodiment of the invention.

### DETAILED DESCRIPTION OF THE INVENTION

We will again consider a heterogeneous cellular network made up of macro-cells and small cells (within the meaning defined above), deployed within the macro-cells. One typical example of a heterogeneous network is a network of the LTE or LTE-A type.

The association method consists of assigning each terminal from among a plurality J of terminals or UE (User Equipment) a cell, or equivalently a base station, from among a plurality N of base stations. More specifically, if UEⱼ, j=1, . . . , J denotes the terminals and BSᵢ, i=1, . . . , N denotes the base stations, the association of terminals with the base stations is defined by an injection S of the set SUE={UE₁, . . . UEⱼ} into the set SBS={SBS₁, . . . , SBS_{N}}, associating each terminal UEⱼ with a base station BSᵢ=S(UEⱼ). The association can also be defined by the set of pairs (UEⱼ,S(UEⱼ)), j=1, . . . , J formed by the terminals and the base stations with which they are associated. The set of possible associations S between the terminals and base stations is denoted Γ.

The association method can be launched upon the admission of the terminal into the network or before initiating a handover operation, or at the initiative of the terminal when it observes a deterioration in the quality of the radio link, at the initiative of a base station, or periodically for all or part of the network.

The idea at the base of the invention is to optimize the association of the terminals with base stations by accounting for at least one constraint on the use of terminals by different users.

When an emission power is assigned to each terminal, one of the constraints can be a maximum percentage of terminals able to emit with powers greater than their respective setpoint powers.

When a setpoint throughput is assigned to each terminal, one of the constraints can be a maximum percentage of terminals able to receive data with throughputs lower than their respective setpoint throughputs.

When the quality of service level is required for the radio link (downlink) of each terminal, one of the constraints can be a maximum percentage of terminals whereof the radio links do not respect the required quality of service levels.

The constraints can be of the same type (emission power, setpoint throughput, quality of service level) for all of the terminals. Alternatively, they can differ from one terminal to another. Furthermore, a terminal may be subject to different constraints of different types. Thus, a terminal may participate in a constraint pertaining to the setpoint throughput, but not to a constraint pertaining to the emission power.

Other constraints relative to the use of the terminals may be considered by one skilled in the art without going beyond the scope of the present invention.

In general, if the usage parameters of the different terminals UEⱼ are denoted lⱼ^{k}, k=1, . . . , K with K≧1, the JK constraints Lⱼ^{k} can be represented by a polytope V_{L} with dimension JK in the space of the usage parameters. When the point Ω with coordinates lⱼ^{k}, j=1, . . . , J, k=1, . . . , K belongs to the polytope V_{L}, the constraints on the usage parameters of the terminals are respected.

The association method according to the present invention seeks to maximize a metric characteristic of the overall capacity of the radio links between the terminals and the base stations that are respectively associated with them.

According to a first alternative embodiment, the metric characteristic of the overall capacity of the radio links is expressed in the form:

$$μ ( C ( S ) ) = {\sum }_{( {UE}_{j} , {B}_{i} = S ( {UE}_{j} ) )} {C}_{ij} \qquad ( 1 )$$

where Cᵢⱼ is the capacity of the channel (downlink) between the base station BSᵢ and the terminal UEⱼ, and S is the considered association. The expression μ(C(S)) recalls that the value of the metric depends on the association S being considered.

According to a second alternative embodiment, the metric characteristic of the overall capacity of the radio links is expressed in the form:

$$μ ( C ( S ) ) = {\sum }_{( {UE}_{j} , {B}_{i} = S ( {UE}_{j} ) )} log {C}_{ij} \qquad ( 2 )$$

to make it possible to obtain an equitable distribution of the load between base stations. Indeed, a load distribution different from that which maximizes equation (2) and that would increase a user's capacity would lead to a reduction in the overall average capacity of the system. A description of the concept of equitable allocation of radio resources can be found in the article by H. Kim and Y. Han titled “A proportional fair scheduling for multicarrier transmission systems,” IEEE Communications Letters, vol. 9, no. 3, pp. 210-212, March 2005.

When the heterogeneous network is a network of the LTE or LTE-A type, the capacity of the channel Cᵢⱼ between the base station BSᵢ and the terminal UEⱼ taking place in the computation of the metric (1) or (2) can be determined from the measurement RSRPᵢⱼ of the power of the cell specific reference signals i received by the terminal UEⱼ. More specifically, RSRPᵢⱼ is obtained as the average of the power of the signals CSRSᵢ received by the terminal UEⱼ, the average being computed on the recess elements used by the base station BSᵢ. The capacity Cᵢⱼ is obtained using Shannon's formula:

Cᵢⱼ=Fᵢⱼ log ₂(1+SINRᵢⱼ) (3)

where SINRᵢⱼ indicates the average ratio between the power of the signal of the base station i measured by the user j and the sum of the thermal variance noise σ² plus the interference generated by the adjacent base stations, i.e.:

$${SIN R}_{ij} = \frac{{RSRP}_{ij}}{{\sum }_{k \neq i} {RSRP}_{kj} + {σ}^{2}} \qquad ( 4 )$$

The factor Fᵢⱼ indicates the average quantity of frequency resources that can be allocated to the user j. If the total band (F) is shared between the users associated with a base station i, one has:

$${F}_{ij} = \frac{F}{{\sum }_{( {UE}_{j} , {B}_{i} = S ( {UE}_{j} ) )} 1} \qquad ( 5 )$$

The association method then looks in the set Γ of possible associations, for the subset Γ_{L} of associations making it possible to verify the constraints of different users. The optimal association, denoted S*, is then determined, verifying:

$${S}^{*} = {arg}_{S ∈ {Γ}_{L}} max ( μ ( S ) ) \qquad ( 6 )$$

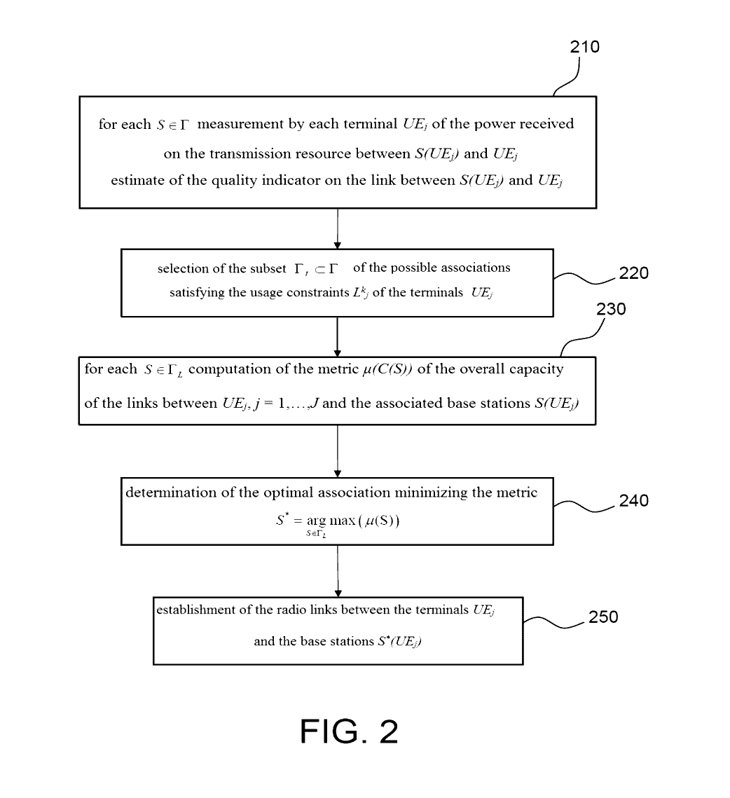

FIG. 2 diagrammatically shows the method for associating terminals with cells according to one embodiment of the invention.

In step 210, for each possible association SεΓ, each terminal UEⱼ, j=1, . . . , J performs a power measurement on the transmission resource used by the base station BSᵢ=S(UEⱼ). This transmission resource can be that used by reference signals of the cell i served by the base station BSᵢ. The power thus measured is next used to estimate a quality indicator of the radio link between base stations BSᵢ=S(UEⱼ) and the terminal UEⱼ.

For example, if the cellular network is an LTE or LTE-A network, the power measurement is done on the signals CSRSs and the quality index thus estimated is the index RSRQ.

In step 220, among the set Γ of possible associations, a subset Γ_{L} of possible associations is selected satisfying the usage constraints Γⱼ^{k} of the terminals UEⱼ, j=1, . . . , J. The selection of the subset of possible associations satisfying these constraints is made from quality indicators of the radio links estimated in the preceding step. The subset may be chosen as that best satisfying the usage constraints Lⱼ^{k}, for example minimum emission power, maximum throughput, maximum quality of service, a maximum electromagnetic power at a predetermined distance of each terminal, or percentage of terminals not satisfying the required power setpoints, throughputs and qualities of service corresponding to a minimum, or any combination of the above-mentioned constraints. When the constraints are linear, the associations making it possible to obtain the best satisfaction of the constraints are those which correspond to the surface of the polytope V_{L}.

In step 230, for each association S of the subset Γ_{L}, the value of a metric μ(C(S)) characteristic of the overall capacity of the radio links between the terminals UEⱼ, j=1, . . . , J SUE and the base stations associated with them S(UEⱼ) is computed. The metric may in particular have the form given by expression (1) or expression (2).

In step 240, lastly, the optimal association S* is determined that minimizes the overall capacity of said radio links, in other words

$${S}^{*} = {arg}_{S ∈ {Γ}_{L}} max ( μ ( S ) ) .$$

The determination of the optimal association in step 240 can be displayed using a so-called brute force approach, in which all of the possible associations of the set Γ_{L} are exhaustively reviewed. Alternatively, when the constraints are linear, the search for the optimal association may be done using the Lagrange multipliers method, known in itself. Also alternatively, the search may be done using a steepest descent algorithm, also known in itself.

Lastly, in step 250, the radio links are established between the terminals and the base stations associated with those terminals according to the optimal association determined in the preceding step. In other words, a link is established between the terminals UEⱼ and the base stations S*(UEⱼ).

The association method can be implemented in a centralized manner or in a distributed manner within the network. In a centralized solution, the measurements relative to the radio links are done by the users' terminals, then collected and sent by the base stations to a dedicated controller that determines the optimal association. This controller may be hosted by the base station serving the macro-cell or by a server loaded with network operating and management functionalities, called Operation And Management (OAM) server.

1: A method for associating terminals with cells in a heterogeneous telecommunications network comprising at least one macro-cell and a plurality of cells, called small cells, with a substantially smaller size than said macro-cell and that are deployed within the latter, the macro-cell and said small cells being served by a plurality of base stations, each terminal being able to establish a radio link with a base station using a frequency resource, comprising:
performing, via each terminal, a power measurement on the frequency resource so as to obtain, for each possible association associating that terminal with a base station, a quality index of a radio link between the terminal and that base station;
selecting, among the set (Γ) of possible associations between terminals and base stations, a subset (Γ_{L}) of associations satisfying at least one constraint (L) relative to the use of said terminals, the selection being done from quality indices of the radio links;
computing for each possible association of said subset, a metric characteristic of the overall capacity of the radio links between terminals and base stations associated using this possible association and an optimal association (S*) is determined maximizing this metric; and
establishing radio links between the terminals and the base stations associated using the optimal association (S*) thus determined.

2: The method for associating terminals with cells according to claim 1, wherein a setpoint power being assigned to each terminal, the constraint relative to the use of the terminals is the maximum percentage of the terminals able to emit with powers higher than their respective setpoint powers.

3: The method for associating terminals with cells according to claim 1, wherein a setpoint throughput being assigned to each terminal, the constraint relative to the use of the terminals is a maximum percentage of terminals able to receive data throughputs lower than their respective setpoint throughputs.

4: The method for associating terminals with cells according to claim 1, wherein a quality of service (QoS) level being required by each terminal, the constraint relative to the use of the terminals is a maximum percentage of terminals able to have quality of service levels lower than the quality of service levels that they respectively required.

5: The method for associating terminals with cells according to claim 1, wherein said set of possible associations satisfies a plurality of constraints relative to the use of said terminals, said plurality of constraints being chosen among any combination of:
the maximum percentage of the terminals able to emit with powers higher than their respective setpoint powers;
a maximum percentage of terminals able to receive data throughputs lower than their respective setpoint throughputs;
a maximum percentage of terminals able to have quality of service levels lower than the quality of service levels that they respectively required;
a maximum electromagnetic power at a predetermined distance of each terminal.

6: The method for associating terminals with cells according to claim 1, wherein the metric of the radio links between the terminals UEⱼ, j=1, . . . , J and base stations BSᵢ, i=1, . . . , N is defined by
$${\sum }_{( {UE}_{j} , {BS}_{i} - S ( {UE}_{j} )} {C}_{ij}$$
where Cᵢⱼ is the capacity of the channels between the base station BSᵢ and the terminal UEⱼ, and S is one possible association of said subset.

7: The method for associating terminals with cells according to claim 1, wherein the metric of the radio links between the terminals UEⱼ, j=1, . . . , J and the base stations BSᵢ, i=1, . . . , N is defined by
$${\sum }_{( {UE}_{j} , {BS}_{i} = S ( {UE}_{j} )} log {C}_{ij}$$
where Cᵢⱼ is the capacity of the channels between the base station BSᵢ and the terminal UEⱼ, and S is one possible association of said subset.

8: The method for associating terminals with cells according to claim 6, wherein the heterogeneous telecommunications network is an LTE or LTE-A network, and in that the capacity of the channel Cᵢⱼ is computed from the measurement RSRPᵢⱼ obtained as the average power of the signals CSRSᵢ, specific to the cell served by the base station BSᵢ, on the resource element of that base station.

9: The method for associating terminals with cells according to claim 1, wherein the method is executed with a predetermined period.

10: The method for associating terminals with cells according claim 1, wherein the method is executed automatically each time a terminal requests to connect to the network.

11: The method for associating terminals with cells according to claim 1, wherein the method is executed automatically upon each handover procedure of a terminal.

12: The method for associating terminals with cells according to claim 1, wherein the method is executed on request by a terminal when its battery level is lower than a predetermined threshold level.

13: The method for associating terminals with cells according to claim 1, wherein the method is executed in a distributed manner within different base stations.

14: The method for associating terminals with cells according to claim 1, wherein the method is executed in a centralized manner by a controller situated in the base station of the macro-cell.

15: The method for associating terminals with cells according to claim 1, wherein the maximization of the metric on the subset of associations respecting said usage constraint is obtained using the Lagrange multipliers method.
